(19) United States
(12) Patent Application Publication
(10) Pub. No.: US 2010/0146001 A1
(43) Pub. Date: Jun. 10, 2010

(54) SYSTEMS FOR GENERATING DOMAIN NAMES RELEVANT TO CURRENT EVENTS

(75) Inventor: Yong Lee, Chandler, AZ (US)

Correspondence Address: GO DADDY GROUP, INC., 14455 NORTH HAYDEN ROAD, SUITE 219, SCOTTSDALE, AZ, 85260, US

(73) Assignee: THE GO DADDY GROUP, INC., Scottsdale, AZ (US)

(21) Appl. No.: 12/328,616

(22) Filed: Dec. 4, 2008

(51) Int. Cl. G06F 17/30; G06F 15/16; G06F 7/06; G06F 7/00

(52) U.S. Cl. 707/792; 709/206; 707/E17.107; 707/827

(57) ABSTRACT

Systems of the present inventions allow for generating domain names relevant to current events. An exemplary system may comprise a website (hosted on at least one server) that may have one or more fields for submitting a request for a domain name that relates to current events, wherein the request may not include a keyword, search term, or suggested domain name. The system also may comprise a domain name generation module and a domain name registration module, both of which may run on at least one server. The domain name generation module may generate at least one domain name relevant to current events, and the domain name registration module may offer such generated domain names for registration, if available. The system also may comprise a network communicatively coupling the at least one server, domain name generation module, and domain name registration module.

### CROSS REFERENCE TO RELATED PATENT APPLICATIONS

This patent application is related to U.S. patent application Ser. No. ______ entitled: “Generating Domain Names Relevant to Current Events” concurrently filed herewith and also assigned to The Go Daddy Group, Inc.

### FIELD OF THE INVENTION

The present inventions generally relate to domain name registration and, more particularly, systems and methods for generating domain names relevant to current events.

### SUMMARY OF THE INVENTION

An example embodiment of a method for generating domain names relevant to current events may comprise the steps of receiving a request for an available domain name that relates to current events (wherein the request may not include a keyword, search term, or suggested domain name), generating the domain name, determining whether the domain name is available for registration, and providing the domain name for registration (if available).

An example embodiment of a system for generating domain names relevant to current events may comprise a website (hosted on at least one server) that may have one or more fields for submitting a request for a domain name that relates to current events, wherein the request may not include a keyword, search term, or suggested domain name. The system also may comprise a domain name generation module and a domain name registration module, both of which may run on at least one server. The domain name generation module may generate at least one domain name relevant to current events, and the domain name registration module may offer such generated domain names for registration, if available. The system also may comprise a network communicatively coupling the at least one server, domain name generation module, and domain name registration module.

The above features and advantages of the present inventions will be better understood from the following detailed description taken in conjunction with the accompanying drawings.

### BRIEF DESCRIPTION OF THE DRAWINGS

FIG. 1 is a flow diagram illustrating a possible embodiment of a method for generating domain names relevant to current events.

FIG. 2 is a flow diagram illustrating a possible embodiment of a method for generating domain names relevant to current events.

FIG. 3 is a flow diagram illustrating a possible embodiment of a method for generating domain names relevant to current events.

FIG. 4 is a flow diagram illustrating a possible embodiment of a method for generating domain names relevant to current events.

FIG. 5 illustrates a possible embodiment of a system for generating domain names relevant to current events.

FIG. 6 illustrates a possible embodiment of a system for generating domain names relevant to current events.

FIG. 7 illustrates a possible embodiment of a system for generating domain names relevant to current events.

FIG. 8 illustrates a possible embodiment of a system for generating domain names relevant to current events.

FIG. 9 illustrates a possible embodiment of a system for generating domain names relevant to current events.

FIG. 10 illustrates a possible embodiment of a system for generating domain names relevant to current events.

### DETAILED DESCRIPTION

The present inventions will now be discussed in detail with regard to the attached drawing figures which were briefly described above. In the following description, numerous specific details are set forth illustrating the Applicant's best mode for practicing the inventions and enabling one of ordinary skill in the art to make and use the inventions. It will be obvious, however, to one skilled in the art that the present inventions may be practiced without many of these specific details. In other instances, well-known machines, structures, and method steps have not been described in particular detail in order to avoid unnecessarily obscuring the present inventions. Unless otherwise indicated, like parts and method steps are referred to with like reference numerals.

A network is a collection of links and nodes (e.g., multiple computers and/or other devices connected together) arranged so that information may be passed from one part of the network to another over multiple links and through various nodes. Examples of networks include the Internet, the public switched telephone network, the global Telex network, computer networks (e.g., an intranet, an extranet, a local-area network, or a wide-area network), wired networks, and wireless networks.

The Internet is a worldwide network of computers and computer networks arranged to allow the easy and robust exchange of information between computer users. Hundreds of millions of people around the world have access to computers connected to the Internet via Internet Service Providers (ISPs). Content providers place multimedia information (e.g., text, graphics, audio, video, animation, and other forms of data) at specific locations on the Internet referred to as webpages. Websites comprise a collection of connected, or otherwise related, webpages. The combination of all the websites and their corresponding webpages on the Internet is generally known as the World Wide Web (WWW) or simply the Web.

For Internet users and businesses alike, the Internet continues to be increasingly valuable. More people use the Web for everyday tasks, from social networking, shopping, banking, and paying bills to consuming media and entertainment. E-commerce is growing, with businesses delivering more services and content across the Internet, communicating and collaborating online, and inventing new ways to connect with each other.

Prevalent on the Web are multimedia websites, some of which may offer and sell goods and services to individuals and organizations. Websites may consist of a single webpage, but typically consist of multiple interconnected and related webpages. Websites, unless extremely large and complex or have unusual traffic demands, typically reside on a single server and are prepared and maintained by a single individual or entity. Menus and links may be used to move between different webpages within the website or to move to a different website as is known in the art. The interconnectivity of webpages enabled by the Internet can make it difficult for Internet users to tell where one website ends and another begins.

Websites may be created using HyperText Markup Language (HTML) to generate a standard set of tags that define how the webpages for the website are to be displayed. Users of the Internet may access content providers' websites using software known as an Internet browser, such as MICROSOFT INTERNET EXPLORER or MOZILLA FIREFOX. After the browser has located the desired webpage, it requests and receives information from the webpage, typically in the form of an HTML document, and then displays the webpage content for the user. The user then may view other webpages at the same website or move to an entirely different website using the browser.

Browsers are able to locate specific websites because each website, resource, and computer on the Internet has a unique Internet Protocol (IP) address. Presently, there are two standards for IP addresses. The older IP address standard, often called IP Version 4 (IPv4), is a 32-bit binary number, which is typically shown in dotted decimal notation, where four 8-bit bytes are separated by a dot from each other (e.g., 64.202.167.32). The notation is used to improve human readability. The newer IP address standard, often called IP Version 6 (IPv6) or Next Generation Internet Protocol (IPng), is a 128-bit binary number. The standard human readable notation for IPv6 addresses presents the address as eight 16-bit hexadecimal words, each separated by a colon (e.g., 2EDC:BA98:0332:0000:CF8A:000C:2154:7313).

IP addresses, however, even in human readable notation, are difficult for people to remember and use. A Uniform Resource Locator (URL) is much easier to remember and may be used to point to any computer, directory, or file on the Internet. A browser is able to access a website on the Internet through the use of a URL. The URL may include a Hypertext Transfer Protocol (HTTP) request combined with the website's Internet address, also known as the website's domain name. An example of a URL with a HTTP request and domain name is: http://www.companyname.com. In this example, the “http” identifies the URL as a HTTP request and the “companyname.com” is the domain name.

Domain names are much easier to remember and use than their corresponding IP addresses. The Internet Corporation for Assigned Names and Numbers (ICANN) approves some Generic Top-Level Domains (gTLD) and delegates the responsibility to a particular organization (a “registry”) for maintaining an authoritative source for the registered domain names within a TLD and their corresponding IP addresses. For certain TLDs (e.g., .biz, .info, .name, and .org) the registry is also the authoritative source for contact information related to the domain name and is referred to as a “thick” registry. For other TLDs (e.g., .com and .net) only the domain name, registrar identification, and name server information is stored within the registry, and a registrar is the authoritative source for the contact information related to the domain name. Such registries are referred to as “thin” registries. Most gTLDs are organized through a central domain name Shared Registration System (SRS) based on their TLD.

The process for registering a domain name with .com, .net, .org, and some other TLDs allows an Internet user to use an ICANN-accredited registrar to register their domain name. For example, if an Internet user, John Doe, wishes to register the domain name “mycompany.com,” John Doe may initially determine whether the desired domain name is available by contacting a domain name registrar. The Internet user may make this contact using the registrar's webpage and typing the desired domain name into a field on the registrar's webpage created for this purpose. Upon receiving the request from the Internet user, the registrar may ascertain whether “mycompany.com” has already been registered by checking the SRS database associated with the TLD of the domain name. The results of the search then may be displayed on the webpage to thereby notify the Internet user of the availability of the domain name. If the domain name is available, the Internet user may proceed with the registration process. If the domain name is not available for registration, the Internet user may keep selecting alternative domain names until an available domain name is found.

Applicant has noticed that Internet users often wish to register domain names that relate to current events, such as an event reported in the news. For example, if an earthquake occurred in Scottsdale, Ariz., an Internet user may wish to register the domain name “arizonaearthquake.com” to develop a fundraising and charity website for earthquake victims. Applicant also has noticed that domain names that are relevant to current events may have a higher resale value on secondary domain name markets, such as GODADDY.COM's GODADDY AUCTIONS service. Applicant has determined that presently-existing systems and methods do not provide optimal means for suggesting domain names that may relate to current events. For these reasons, there is a need for the systems and methods for generating domain names relevant to current events (and related functionality) as described herein.

Methods for Generating Domain Names Relevant to Current Events

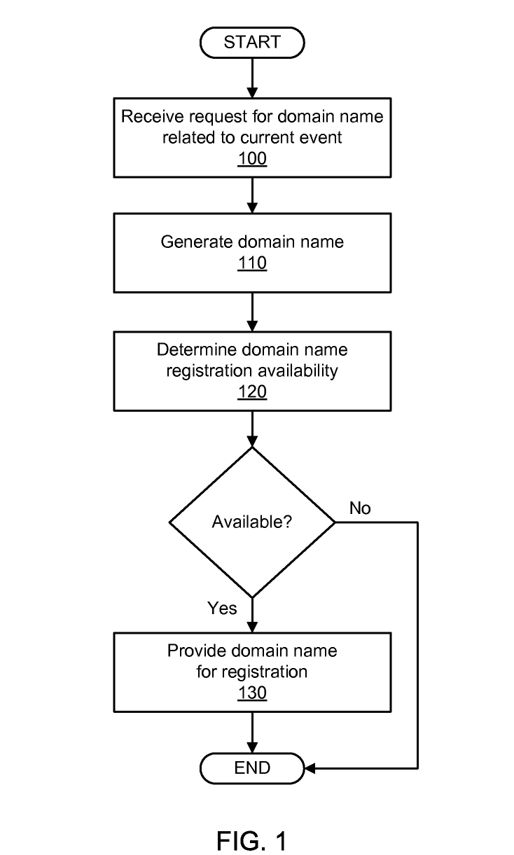

FIG. 1 illustrates a streamlined embodiment of a domain name generation method that may be performed by at least one microprocessor on at least one server executing a plurality of instructions stored on at least one computer-readable media. The method may comprise the steps of receiving, by at least one server communicatively coupled to a network, a request for a domain name that relates to current events, wherein the request does not include a keyword, search term, or suggested domain name (Step 100); generating, by the at least one server, the domain name (Step 110); determining, by the at least one server, whether the domain name is available for registration (Step 120); and providing, by the at least one server, the domain name for registration, if available (Step 130).

As a non-limiting example, the method illustrated in FIG. 1 (and all methods described herein) may be performed by any central processing unit (CPU) in any computing system, such as a microprocessor running on a server, and executing instructions stored (perhaps as scripts and/or software) in computer-readable media accessible to the CPU, such as a hard disk drive on a server. Such a server may be communicatively coupled to a network (e.g., the Internet) and may receive a request for a domain name that relates to current events (Step 100).

The request may come from any individual or entity having access to the network that may wish to research potential domain names for registration and may comprise any electronic request received by the server including, but not limited to, a Hyper Text Transfer Protocol (HTTP) request, email message, and/or Short Message Service (SMS) message (i.e., text message). The request may comprise any combination of data seeking information relating a domain name relevant to current events. The request may or may not include a keyword, search term, or suggested domain name. As non-limiting examples, the request may comprise an HTTP request initiated by a domain name registrar's website, perhaps by clicking a button entitled “Generate domain name based on current events.” Alternatively, a list of current events may be provided on the website. The request may be generated when a potential registrant selects at least one current event upon which he would like domain names generated.

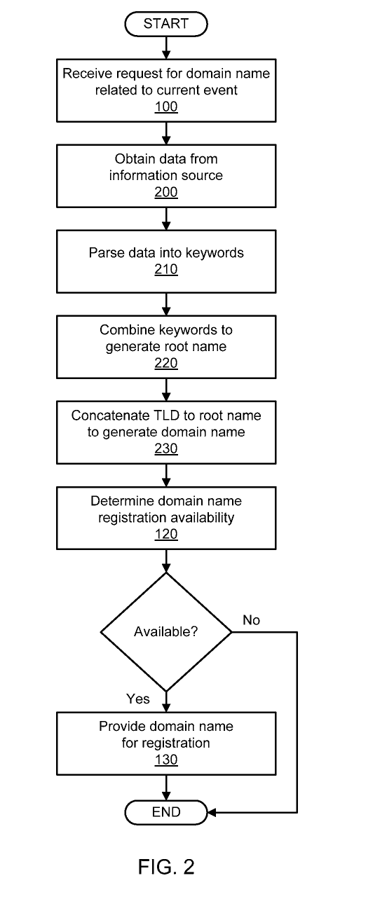

Once the request is received, a domain name relevant to current events may be generated (Step 110), perhaps by domain name generation scripts and/or software running on the server. Any method of generating a domain name that may relate in any manner to current events may be used. As a non-limiting example (and as illustrated in FIG. 2), the generating step (Step 110) may be accomplished by obtaining a plurality of data from an information source (Step 200). The information source may comprise any collection of data, accessible to the entity performing this step (e.g., server), that may contain data regarding current events, recent news, etc. including, but not limited to websites, webpages, news feeds, and/or Real Simple Syndication (RSS) feeds.

Thus, the plurality of data may comprise text on a news-related webpage or website. In such an example embodiment, webpage and/or website text may be obtained (Step 200), perhaps by the server making an HTTP request of a news website and receiving pages having text in response. Alternatively, the plurality of data may comprise text received from a news or RSS feed, perhaps via a feed reader. In an example feed/feed reader embodiment, a feed reader (perhaps running on the server) may obtain the plurality of data (e.g., text) from a news or RSS feed. The “feed reader” (or aggregator) may comprise scripts and/or software that aggregates web content such as news headlines, blogs, podcasts, etc. A “feed” is a data format (perhaps XML-based) used for providing users with frequently-updated content. Two common feed formats that may be used with the present invention are RSS and Atom.

Once text from the information source is obtained (Step 200), it may be parsed into a plurality of keywords (Step 210). Parsing is the process of analyzing a sequence of tokens to determine its grammatical structure with respect to a given formal grammar. Parsing transforms input text into a data structure, such as the keywords used here. As a non-limiting example, if a news website contains an article entitled “Serious Earthquake Occurs in Scottsdale, Ariz.—No Aftershocks Reported,” software and/or scripts running on the server may parse the article title into, among others, the keywords “arizona,” “serious,” “Scottsdale,” “aftershocks,” and/or “earthquake.” Alternatively, the text of the article (rather than merely the title) may be parsed.

With the instant inventions, text may be parsed using any parsing methodology known in the art including, but not limited to, top-down parsing and/or bottom-up parsing. The parsing process also may include glyph or character substitution (i.e., identifying typographically improper characters and substituting characters that result in potentially-meaningful keywords). For example, the parsing process may replace the “0” in the domain name, “g0daddy.com” with an “o,” resulting in more effective keyword parsing because “go” is more likely a valid keyword than “g0.”

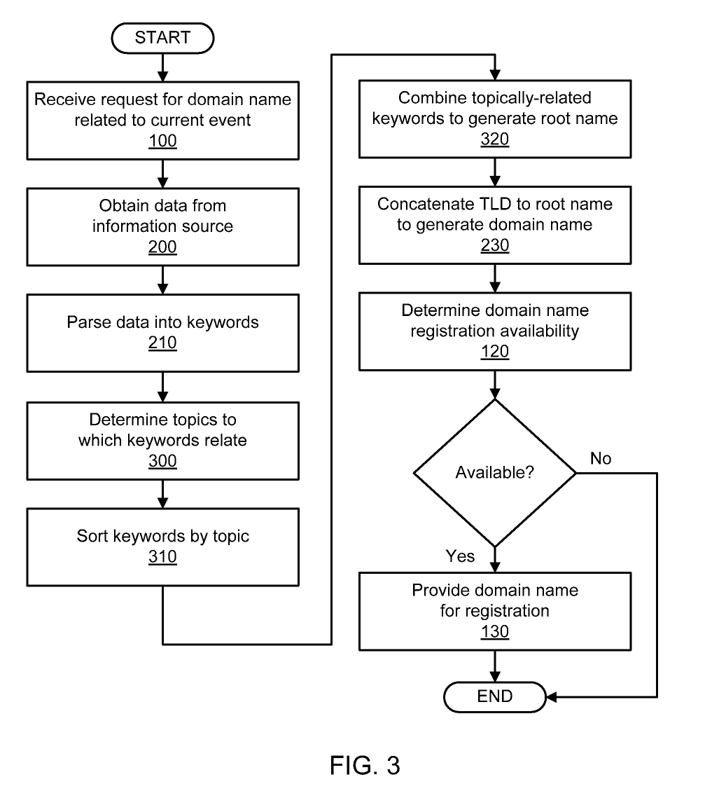

Keywords then may be combined to form a root name (Step 220). The root name may comprise any combination, sequence, or order of any of the keywords generated in Step 210. Continuing with the example of the preceding paragraph, scripts and/or software running on the server may generate a root name by combining the keywords “arizona” and “earthquake” into the root name “arizonaearthquake,” and/or combining the keywords “Scottsdale” and “aftershocks” into the root name “scottsdaleaftershocks.”

Where the information source comprises information regarding numerous different current events, the information may be divided into subcategories before the root name is generated to ensure the root name relates to a single event. As a non-limiting example illustrated in FIG. 3, the keyword combining step (Step 220) may be accomplished by determining a topic to which each keyword relates (Step 300). For example, if a news feed contains the following two headlines: “Serious Earthquake Occurs in Scottsdale, Ariz.—No Aftershocks Reported” and “World Champions! Arizona beats New York to win World Series,” the keywords “aftershock” and “Scottsdale” may be assigned to the topic: “earthquake” while the keywords “arizona” and “worldchampions” may be assigned to the topic: “world series.”Keywords then may be sorted into subcategories by topic (Step 310). Thus, the example's “earthquake” subcategory would include the keywords “aftershock” and “Scottsdale,” while the “world series” subcategory would include the keywords “arizona” and “worldchampions.” A root name then may be generated by combining at least one of the keywords within the same subcategories (Step 320) (e.g., “scottsdaleaftershock” and/or “arizonaworldchampions”).

Top-level domains (TLDs) then may be concatenated to the root name to generate a domain name (Step 230). For example, the TLD “.com” may be concatenated to the root name “arizonaearthquake,” generating the domain name “arizonaearthquake.com” or the TLD “.info” may be concatenated to the root name “scottsdaleaftershock,” generating the domain name “scottsdaleaftershock.info.” As a non-limiting example, a software-based random TLD generator may be implemented to select TLDs to concatenate to root names. Alternatively, software running on the server may generate the most appropriate TLD based upon the content of the information source, keywords, or root name. Any method of suggesting a concept-relevant TLD may be used including, but not limited to, those set forth in U.S. patent application Ser. No. 12/055,905 entitled: “Suggesting Concept-Based Top-Level Domain Names,” which is assigned to The Go Daddy Group, Inc. and incorporated herein by reference.

The registration availability of the domain name then may be determined (Step 120), perhaps by at least one server ascertaining whether the domain name (e.g., “arizonaearthquake.com”) has already been registered by checking the SRS database associated with the TLD of the domain name (.com in the instant example). As an additional non-limiting example, any of the systems and/or methods may be used as described in U.S. Patent Application Publication No. 2004-0199520 entitled: “Method for Checking the Availability of a Domain Name,” which is assigned to The Go Daddy Group, Inc. and incorporated herein by reference. Alternatively, any method of determining domain name registration availability known in the art or developed in the future may be used.

If available, the domain name then may be provided for registration (Step 130). This step may be accomplished by any method of informing a potential registrant that a domain name may be available for registration. As a non-limiting example, where a request for a domain name relating to current events is received (Step 100) via an electronic request (e.g., HTTP request, email message, SMS message, text message), the domain name may be provided for registration (Step 130) via similar electronic communication means, perhaps via a server. Thus, an HTTP domain name request may be responded to with an HTTP response that provides a webpage listing the domain name for registration, perhaps as a hyperlink. If the potential registrant clicks on the domain name, he may be taken to a domain name registration website.

Domain name registration may be accomplished by any domain name registration method known in the art or developed in the future, perhaps via a website-enabled domain name purchase and registration system, such as that described in detail above and/or may be available on GODADDY.COM's website. Alternatively, domain name registration may be accomplished via human to human communication, perhaps via a telephone call or in-person meeting. Domain names may be registered by, as non-limiting examples, any individual or entity including, but not limited to a domain name registry, domain name registrar, hosting provider, and/or software application developer or distributor.

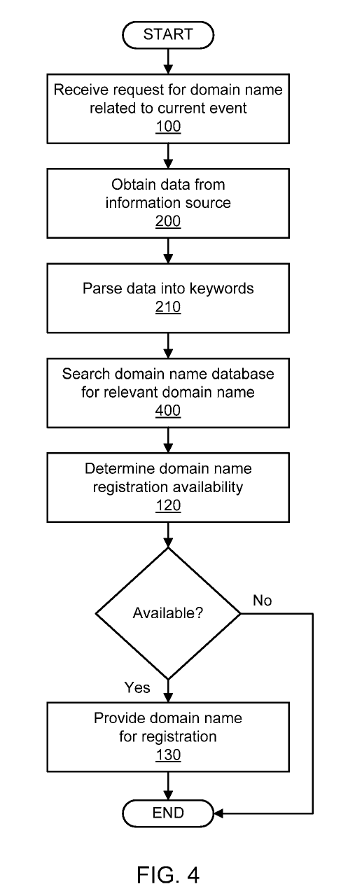

FIG. 4 illustrates an alternate embodiment of a domain name generation method that may be performed by at least one microprocessor on at least one server executing a plurality of instructions stored on at least one computer-readable media. The method may comprise the steps of receiving, by at least one server communicatively coupled to a network, a request for a domain name that relates to current events, wherein the request does not include a keyword, search term, or suggested domain name (Step 100); obtaining a plurality of data from an information source (Step 200); parsing the data into a plurality of keywords (Step 210); searching a domain names database for at least one domain name comprising at least one keyword (Step 400); determining whether the domain name is available for registration (Step 120); and providing the domain name for registration if the domain name is available (Step 130)

Steps 100, 200, 210, 120, and 130 may be accomplished as described in detail above. In this example embodiment, however, once data is parsed into keywords (Step 210), a domain names database may be searched, perhaps by scripts and/or software running on a server, for at least one domain name that may comprise at least one of the keywords (Step 400). This embodiment enables a potential registrant to identify those domain names that, although already registered, may be available for re-registration, perhaps because their registration may expire shortly, or because the domain name registrant wishes to resell his interest in the domain name. The domain name database may be communicatively coupled with the network and may store a plurality of domain names, perhaps those whose registrations are about to expire or are being offered for resale, perhaps via a domain name auction service, such as GODADDY.COM's GODADDY AUCTIONS service.

Systems for Generating Domain Names Relevant to Current Events

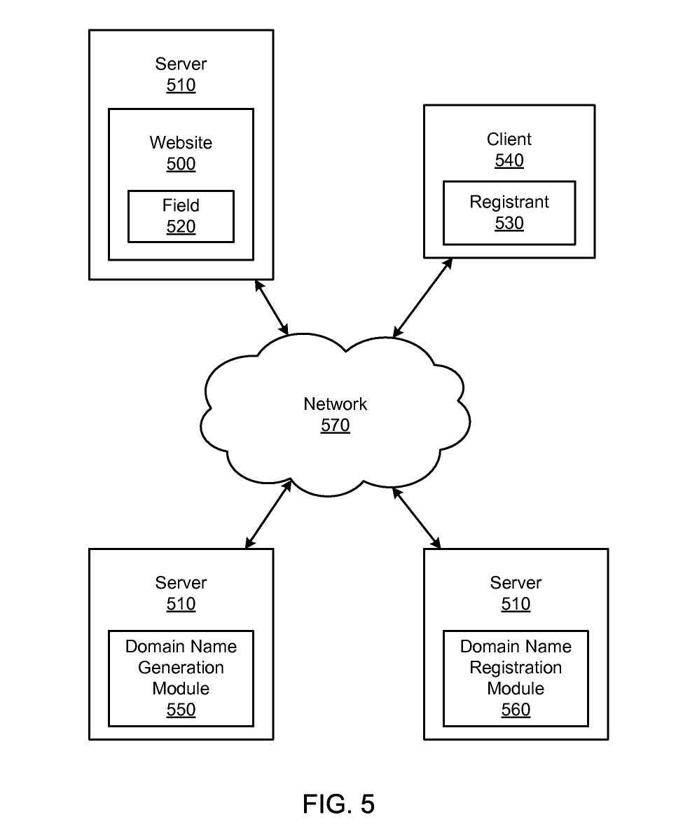

FIG. 5 illustrates a possible embodiment of a system for generating domain names relevant to current events. This example embodiment may comprise a website 500 hosted on at least one server 510 communicatively coupled to a network 570. The network 570 may communicatively couple servers 510 to at least one client 540, which may be accessed by a potential domain name registrant 530. The example embodiments herein place no limitation on network 570 configuration or connectivity. Thus, as non-limiting examples, the network 570 could comprise the Internet, the public switched telephone network, the global Telex network, computer networks (e.g., an intranet, an extranet, a local-area network, or a wide-area network), wired networks, wireless networks, or any combination thereof. Examples of clients 540 that may be used may include a desktop computer, a laptop computer, a hand held computer, a terminal, a television, a television set top box, a cellular phone, a wireless phone, a wireless hand held device, an Internet access device, a rich client, thin client, or any other client functional with a client/server computing architecture.

Servers 510 and clients 540 may be communicatively coupled to the network 570 via any method of network connection known in the art or developed in the future including, but not limited to wired, wireless, modem, dial-up, satellite, cable modem, Digital Subscriber Line (DSL), Asymmetric Digital Subscribers Line (ASDL), Virtual Private Network (VPN), Integrated Services Digital Network (ISDN), X.25, Ethernet, token ring, Fiber Distributed Data Interface (FDDI), IP over Asynchronous Transfer Mode (ATM), Infrared Data Association (IrDA), wireless, WAN technologies (T1, Frame Relay), Point-to-Point Protocol over Ethernet (PPPoE), and/or any combination thereof.

The website 500 may comprise any collection of data and/or files accessible via a browser on a client 540 having access to a network 570 communicatively coupled to the server 510. The at least one server 510 and/or any other server described herein, could be any computer or program that provides services to other computers, programs, or users either in the same computer or over a computer network. As non-limiting examples, the at least one server 510 could be an application, communication, mail, database, proxy, fax, file, media, web, peer-to-peer, or standalone server and may use any server format known in the art or developed in the future (possibly a shared hosting server, a virtual dedicated hosting server, a dedicated hosting server, or any combination thereof).

The website 500 may have one or more fields 520 for submitting a request for an available domain name that relates to current events. The provided request may or may not include a keyword, search term, or suggested domain name. The fields 520 on the website 500 may comprise a button on a webpage allowing a registrant 530 (or other user) to request domain names relevant to current events, perhaps by clicking a button entitled “Generate domain name based on current events.” The website 500 may be configured to send an HTTP request for such domain names when the button is clicked. As a non-limiting alternative, the field 520 may comprise a drop-down menu that presents the registrant 530 with a plurality of options from which to select, including the generation of domain names relevant to current events. Alternatively, a list of current events may be provided on the website 500 from which a current event mat be selected. The field 520 may comprise any means for generating a request for a domain name that relates to current events, wherein the request may or may not include a keyword, search term, or suggested domain name. As non-limiting examples, the field 520 may comprise means for generating and sending an email message, SMS message, and/or other text message, such as email and/or SMS software.

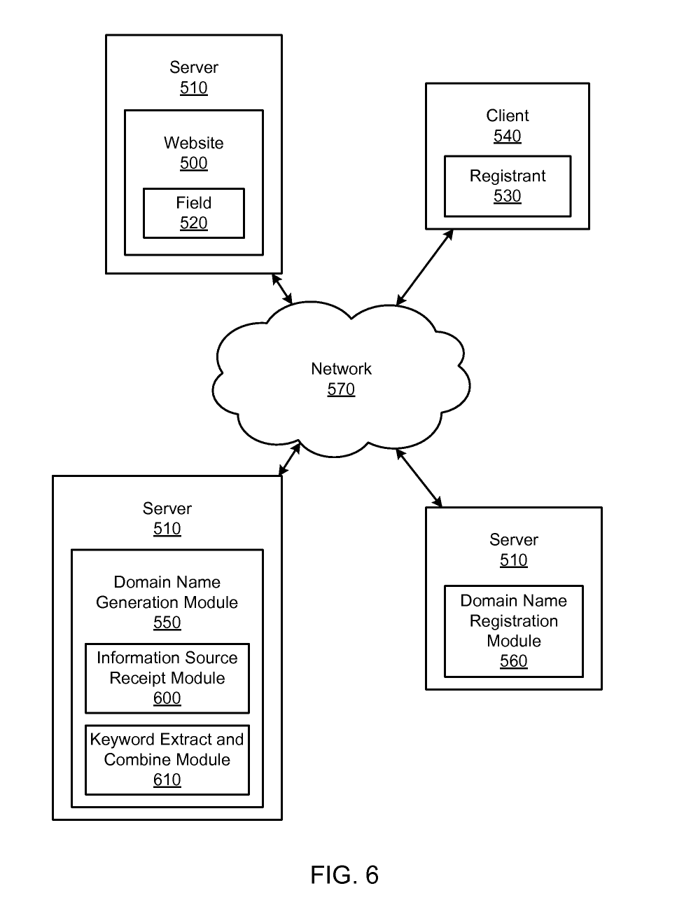

The system also may comprise a domain name generation module 550 that may be stored in the memory of—and run on—at least one server 510 and may comprise any software and/or scripts containing instructions that, when executed by the server's 510 microprocessor, cause the microprocessor to generate a domain name relevant to current events. As illustrated in FIG. 6, the domain name generation module 550 may comprise an information source receipt module 600 and a keyword extraction and combination module 610. The information source receipt module 600 may comprise scripts and/or software running on the server 510 that operates to obtain a plurality of data from any information source. As described in detail above, the information source forming the basis of generated domain names may comprise any collection of data, accessible to the domain name generation module 550 that may contain data regarding current events, recent news, etc. including, but not limited to websites, webpages, news feeds, and/or Real Simple Syndication (RSS) feeds.

The keyword extraction and combination module 610 also may comprise software and/or scripts running on the server 510 and may operate to parse received data into a plurality of keywords, combine keywords into a root name, and concatenate a top level domain to the root name, thereby generating the requested domain name (Steps 210-230). In one possible embodiment, the keyword extraction and combination module 610 also may determine a topic to which each keyword relates (Step 300), sort the keywords into subcategories according to topic (Step 310), and generate a root name by combining keywords from the same subcategory (Step 320). A domain name relevant to current events is thereby generated after a TLD is concatenated to the root name (Step 230). Modules 600 and 610 may comprise any software and/or scripts running on the server 510 that may accomplish Steps 200-230 as described in detail above.

The system also may comprise a domain name registration module 560 running on at least one server 510 and offering the generated domain name for registration (if available). This module may comprise software and/or scripts containing instructions that, when executed by the server's 510 microprocessor, cause the microprocessor to determine whether the domain name is available for registration (Step 120) and provide the domain name for registration, if available (Step 130). Additionally, the domain name registration module 560 may, if the domain name is available, register the domain name to the registrant 530. It may comprise any domain name registration system known in the art or developed in the future including, but not limited to, a website-enabled domain name purchase and registration system, such as that described in detail above and/or may be available on GODADDY.COM's website.

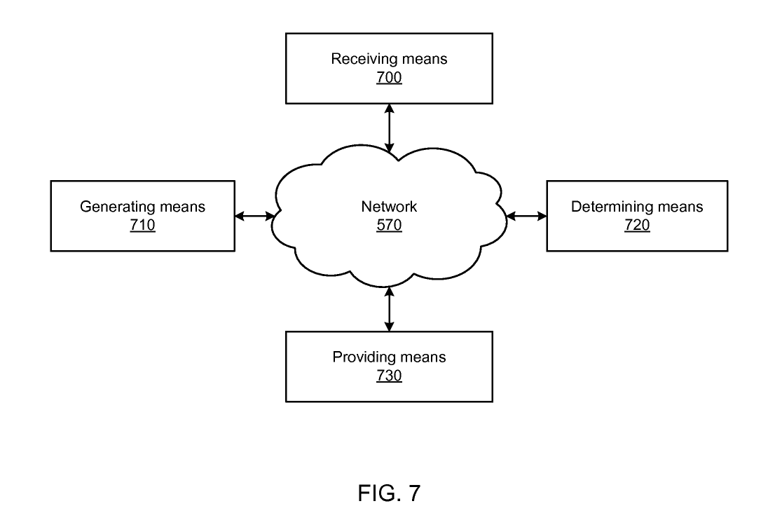

FIG. 7 illustrates another example embodiment of a system for generating domain names relevant to current events. The illustrated embodiment may comprise means for receiving 700 a request for an available domain name that relates to current events (wherein the request does not include a keyword, search term, or suggested domain name); means for generating 710 the domain name; means for determining 720 whether the domain name is available for registration; means for providing 730 the domain name for registration, if available; and a network 570 communicatively coupling the receiving means 700, generating means 710, determining means 720, and providing means 730.

The means for receiving 700 a request for an available domain name may comprise any system for receiving information or data from any source that seeks or requests information regarding a domain name that relates to current events including, but not limited to, the website 500 described in detail above. As additional, non-limiting examples, the means for receiving 700 a request for an available domain name may comprise a telephone-based information collection system (automated or manned), an in-person interview, and/or or an automated or manual data receipt system for receiving information in any form from a prospective registrant 530.

The means for generating 710 domain names that relate to current events may comprise any domain name generation system known in the art or developed in the future that may generate at least one domain name that relates in any manner to current events, news, and/or world happenings. The domain name generation means 710 may comprise any and all variants of the domain name generation module 550 described in detail above.

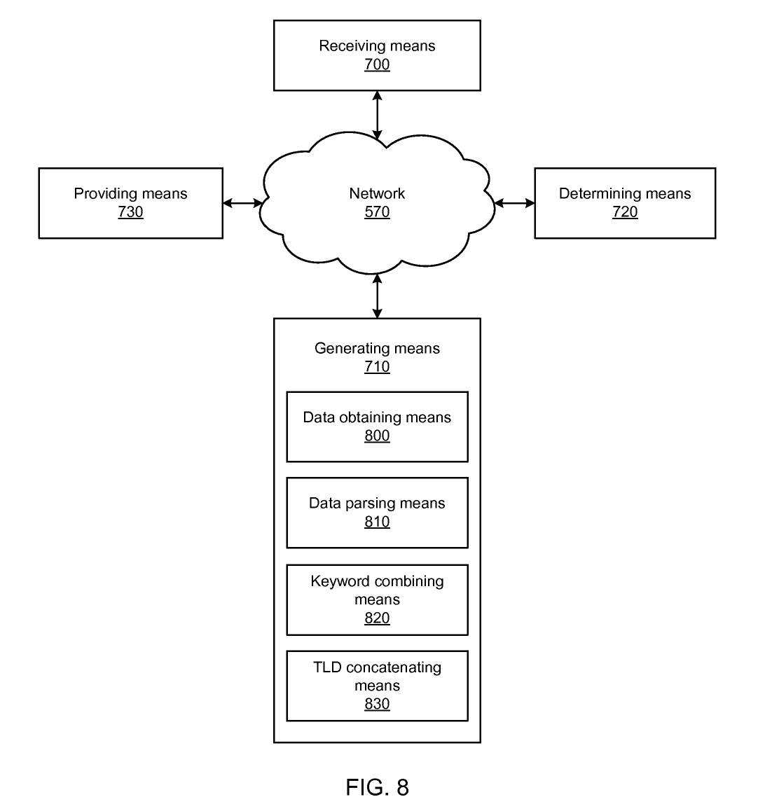

Alternatively, and as illustrated in FIG. 8, the domain name generation means 710 may comprise means for obtaining 800 a plurality of data from an information source, means for parsing 810 such data into a plurality of keywords, means for combining 820 at least one of the keywords into a root name, and means for concatenating 830 a top level domain to the root name to generate the requested domain name. Each of these means (800 though 830) may be implemented by software and/or scripts running on a server 510 that accomplish Steps 200 though 230 as described above.

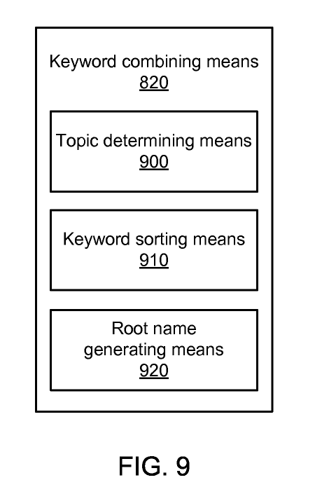

As illustrated in FIG. 9, the keyword combination means 820 further may comprise means for determining 900 a topic to which the keywords relate, means for sorting 910 keywords into a plurality of subcategories according to topic, and means for generating 920 a root name by combining at least one of said keywords in one of said plurality of subcategories. Each of these means (900 though 930) may be implemented by software and/or scripts running on a server 510 that accomplish Steps 300 though 320 as described above.

The means for determining 720 whether the domain name is available for registration and means for 730 providing the domain name to a prospective registrant 530 for registration both may be implemented by any system or method for determining whether the generated domain name is available for registration and presenting such available domain names for registration to a prospective registrant 530. As a non-limiting example, the determining means may comprise any and all variants of the domain name registration module 560 described in detail above.

The means for receiving 700, means for generating 710, means for determining 720, and means for providing 730 may be communicatively coupled to the network 570 via any method of network connection known in the art or developed in the future, including those discussed in detail above.

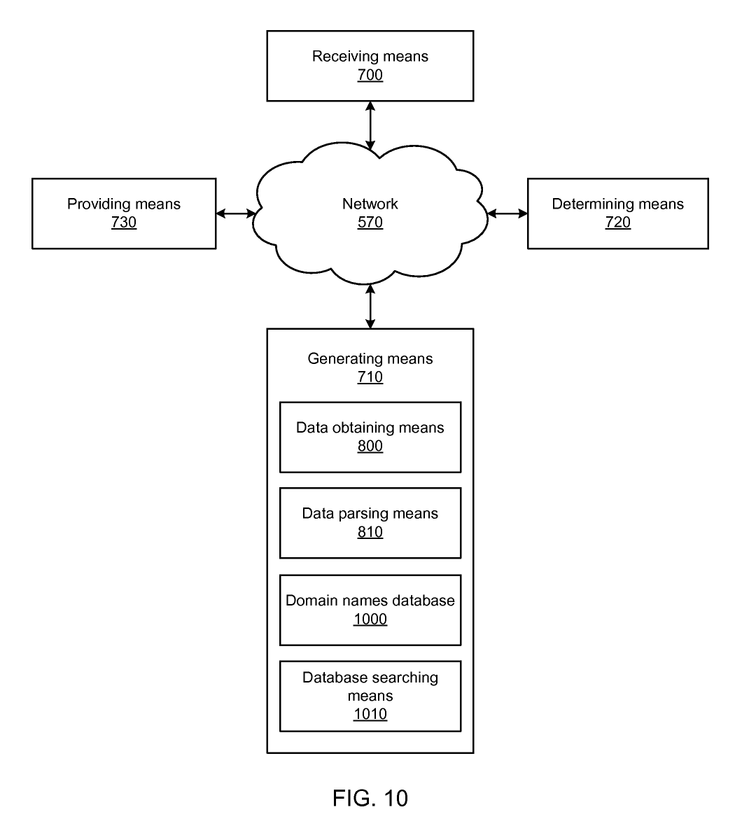

FIG. 10 illustrates an alternate embodiment of the system of FIG. 7, wherein the domain name generation means 710 comprises means for obtaining 800 a plurality of data from an information source, means for parsing 810 the data into a plurality of keywords, a domain names database 1000 storing a plurality of domain names (and being communicatively coupled to the network 570), and means for searching 1010 the domain names database 1000 for at least one domain name comprising at least one of the keywords. In this example embodiment, once data is parsed into keywords (Step 210), the domain names database 1000 may be searched, perhaps by searching means comprising scripts and/or software running on a server, for at least one domain name that may comprise at least one of the keywords (Step 400). This embodiment enables a potential registrant 530 to identify those domain names that, although already registered, may be available for re-registration, perhaps because their registration may expire shortly, or because the current domain name owner/registrant wishes to resell his interest in the domain name, such as GODADDY.COM's GODADDY AUCTIONS service.

The domain names database 1000 may comprise, as non-limiting examples, a local database, online database, desktop database, server-side database, relational database, hierarchical database, network database, object database, object-relational database, associative database, concept-oriented database, entity-attribute-value database, multi-dimensional database, semi-structured database, star schema database, XML database, file, collection of files, spreadsheet, or other means of data storage located on a computer, client, server, or any other storage device known in the art or developed in the future.

An Example Use of Systems and Methods for Generating Domain Names Relevant to Current Events

The systems and methods described herein may be used in many ways to, among other things, generate domain names relevant to current events and provide such domain names to prospective registrants 530 for registration. As a non-limiting example of how such systems and methods may be used, an Internet user (i.e., a prospective registrant 530), via the browser on his client 540 laptop that may be wirelessly connected to the Internet (i.e., the network 570), may navigate to a domain name registrar's website 500. The website 500, which may be hosted on the domain name registrar's server 510, may have a clickable button (i.e., a data field 520) labeled “generate domain names relevant to current events.” When the prospective registrant 530 clicks on the field 520, an HTTP request for such domain names may be generated and received by the domain name registrar (Step 100).

Once the request is received (Step 100), a software-enabled domain name generation module 550, perhaps running on the domain name registrar's server 510, may generate the requested domain name (Step 110) by making an HTTP request of a news website, receiving the text from an article on the news website in response (Step 200), parsing the text into a plurality of keywords (Step 210), combining the keywords to form a root name (Step 220), and then concatenating a TLD to the root name (Step 230). As a non-limiting example, if a news website contained an article entitled “World Champions! Arizona beats New York to win World Series,” the domain name generation module 550 may parse the article title into, among others, the keywords “worldchampions” and “arizona.” The domain name generation module 550 then may generate a root name by combining the keywords “worldchampions” and “arizona” into the root name “arizonaworldchampions.” The TLD “.com” may be concatenated to the root name “arizonaworldchampions,” generating the domain name “arizonaworldchampions.com.”

A software-enabled domain name registration module 560, which also may be running on the domain name registrar's server 510, then may determine the registration availability of the domain name “worldchampiondiamondbacks.com” (Step 120) by checking the SRS database associated with the .com TLD. If available, the domain name registration module 560 then may provide the domain name for registration (Step 130) to the registrant 530 by an HTTP response to the browser on the registrant's 530 client's 540 browser that provides a webpage listing the domain name for registration, perhaps as a hyperlink.

Other embodiments and uses of the above inventions will be apparent to those having ordinary skill in the art upon consideration of the specification and practice of the inventions disclosed herein. The specification and examples given should be considered exemplary only, and it is contemplated that the appended claims will cover any other such embodiments or modifications as fall within the true scope of the inventions.

The Abstract accompanying this specification is provided to enable the United States Patent and Trademark Office and the public generally to determine quickly from a cursory inspection the nature and gist of the technical disclosure and in no way intended for defining, determining, or limiting the present inventions or any of its embodiments.

The inventions claimed are:

1. A system, comprising:
A) a website hosted on at least one server, said website having at least one field for submitting a request for an available domain name that relates to at least one current event, wherein said request does not include a keyword, search term, or suggested domain name;
B) a domain name generation module running on said at least one server and generating said domain name;
C) a domain name registration module running on at said least one server and offering said domain name for registration if said domain name is available; and
D) a network communicatively coupling said at least one server, said domain name generation module and said domain name registration module.

2. The system of claim 1, wherein said domain name generation module comprises:
i) an information source receipt module running on said at least one server and obtaining a plurality of data from an information source; and
ii) a keyword extraction and combination module running on said at least one server and parsing said plurality of data into a plurality of keywords; combining at least one of said keywords into a root name; and concatenating a top level domain to said root name to generate said domain name.

3. The system of claim 2, wherein said information source receipt module comprises a browser.

4. The system of claim 3, wherein said information source comprises a website.

5. The system of claim 4, wherein said plurality of data comprises text on said website.

6. The system of claim 3, wherein said information source comprises a webpage.

7. The system of claim 6, wherein said plurality of data comprises text on said webpage.

8. The system of claim 2, wherein said information source receipt module comprises a feed reader.

9. The system of claim 8, wherein said information source comprises an RSS feed.

10. The system of claim 9, wherein said plurality of data comprises text received from said RSS feed.

11. The system of claim 8, wherein said information source comprises a news feed.

12. The system of claim 11, wherein said plurality of data comprises text received from said news feed.

13. The system of claim 2, wherein said keyword extraction and combination module further determines a topic to which each of said plurality of keywords relates; sorts said plurality of keywords into a plurality of subcategories according to said topic; and generates a root name by combining at least one of said keywords in one of said plurality of subcategories.

14. The system of claim 1, wherein said at least one field comprises a list of current events.

15. The system of claim 14, wherein said domain name generation module generates a domain name that relates to at least one current event, wherein said at least one current event was selected from said list of current events.

16. A system, comprising:
A) means for receiving a request for an available domain name that relates to current events, wherein said request does not include a keyword, search term, or suggested domain name;
B) means for generating said domain name;
C) means for determining whether said domain name is available for registration;
D) means for providing said domain name, if available, for registration; and
E) a network communicatively coupling said receiving means, said generating means, said determining means, and said providing means.

17. The system of claim 16, wherein said request comprises an electronic request.

18. The system of claim 17, wherein said electronic request comprises a HTTP request.

19. The system of claim 17, wherein said electronic request comprises an email.

20. The system of claim 17, wherein said electronic request comprises a SMS message.

21. The system of claim 16, wherein said generating means B) comprises:
i) means for obtaining a plurality of data from an information source;
ii) means for parsing said plurality of data into a plurality of keywords;
iii) means for combining at least one of said keywords into a root name; and
iv) means for concatenating a top level domain to said root name to generate said domain name.

22. The system of claim 21, wherein said information source comprises a website.

23. The system of claim 21, wherein said plurality of data comprises text on said website.

24. The system of claim 21, wherein said information source comprises a webpage.

25. The system of claim 24, wherein said plurality of data comprises text on said webpage.

26. The system of claim 21, wherein said information source comprises an RSS feed.

27. The system of claim 26, wherein said plurality of data comprises text received from said RSS feed.

28. The system of claim 21, wherein said information source comprises a news feed.

29. The system of claim 28, wherein said plurality of data comprises text received from said news feed.

30. The system of claim 21, wherein said combining means iii) comprises:
a) means for determining a topic to which each of said plurality of keywords relates;
b) means for sorting said plurality of keywords into a plurality of subcategories according to said topic; and
c) means for generating a root name by combining at least one of said keywords in one of said plurality of subcategories.

31. The system of claim 16, wherein said generating means B) further comprises:
i) means for obtaining a plurality of data from an information source;
ii) means for parsing said plurality of data into a plurality of keywords;
iii) a domain names database storing a plurality of domain names communicatively coupled to said network; and
iv) means for searching said domain names database for at least one domain name comprising at least one of said plurality of keywords.

32. A system, comprising:
A) means for receiving a HTTP request seeking an available domain name that relates to current events, wherein said HTTP request does not include a keyword, search term, or suggested domain name;
B) means for obtaining a plurality of text from a news feed;
C) means for parsing said plurality of text into a plurality of keywords;
D) means for determining a topic to which each of said plurality of keywords relates;
E) means for sorting said plurality of keywords into a plurality of subcategories according to said topic;
F) means for generating a root name by combining at least one of said keywords in one of said plurality of subcategories;
G) means for concatenating a top level domain to said root name to generate said domain name;
H) means for determining whether said domain name is available for registration; and
I) means for providing, via a HTTP response to said HTTP request, said domain name if available for registration.
